(19) United States
(12) Patent Application Publication
(10) Pub. No.: US 2004/0266575 A1
(43) Pub. Date: Dec. 30, 2004

(54) Crank shaft assembly for bicycle

(76) Inventors: Douglas Chiang, Taichung Hsien (TW); Edwin Jozef Van De Weghe, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/610,050

(22) Filed: Jun. 30, 2003

(51) Int. Cl. G05G 1/14; F16H 7/20

(52) U.S. Cl. 474/197; 74/594.1; 474/160

(57) ABSTRACT

A crank shaft assembly includes a socket, a crank shaft, two roller bearings, two mounting portions, two covers, and two steel ball sets. Thus, the roller bearings and the steel ball sets are arranged in different axial directions to bear the forces of two different directions. In addition, the roller bearings and the steel ball sets are arranged in different axial directions to increase the force bearing area of the crank shaft assembly, thereby preventing from producing stress concentration, so as to increase the lifetime of the crank shaft assembly.

### BACKGROUND OF THE INVENTION

1. Field of the Invention

The present invention relates to a crank shaft assembly, and more particularly to a crank shaft assembly for a bicycle.

2. Description of the Related Art

A conventional crank shaft assembly in accordance with the prior art shown in FIG. 5 comprises a socket 30, a crank shaft 32 rotatably mounted in the socket 30 and provided with two shoulders 34, two ball bearings 36 each mounted on the crank shaft 32 and rested on the respective shoulder 34, and two mounting races 38 each having an outer wall secured in the inner wall of the socket 30 and an inner wall rested on the respective shoulder 34 and the respective ball bearing 36. When the rider is riding the bicycle, the crank shaft assembly has to bear the force of the two cranks (not shown) and the weight of the rider. Thus, the crank shaft assembly needs a larger structural strength to bear the force of the two cranks and the weight of the rider.

However, the ball bearings 36 have to withstand the force of the two cranks and the weight of the rider, so that the ball bearings 36 are easily worn out during a long-term utilization, thereby greatly decreasing the lifetime of the conventional crank shaft assembly.

### SUMMARY OF THE INVENTION

The primary objective of the present invention is to provide a crank shaft assembly that has a larger structural strength to bear the forces and pressures of two different directions (vertical and horizontal directions).

Another objective of the present invention is to provide a crank shaft assembly, wherein the roller bearings and the steel ball sets are arranged in different axial directions so as to enhance the structural strength of the crank shaft assembly and to increase the force bearing area of the crank shaft assembly.

A further objective of the present invention is to provide a crank shaft assembly, wherein the roller bearings and the steel ball sets are arranged in different axial directions so as to bear the forces of different directions.

A further objective of the present invention is to provide a crank shaft assembly, wherein the roller bearings are arranged at a mediate section of the crank shaft and the steel ball sets are arranged at an outer side of the two mounting portions, so that the roller bearings and the steel ball sets are arranged in different axial directions so as to bear the forces and pressures of two different directions (vertical and horizontal directions).

A further objective of the present invention is to provide a crank shaft assembly, wherein the roller bearings and the steel ball sets are arranged in different axial directions so as to increase the force bearing area of the crank shaft assembly, thereby preventing from producing stress concentration, so as to increase the lifetime of the crank shaft assembly.

In accordance with the present invention, there is provided a crank shaft assembly, comprising a socket, a crank shaft, two roller bearings, two mounting portions, two covers, and two steel ball sets, wherein:

the crank shaft is rotatably mounted in the socket and has two ends each formed with a receiving recess;

each of the two roller bearings is mounted in the respective receiving recess of the crank shaft;

each of the two mounting portions is mounted between the socket and the crank shaft and has a distal end formed with an annular shoulder rested on the respective end of the socket;

each of the two covers is secured on the respective end of the crank shaft and is rested on the annular shoulder of the respective mounting portion; and

each of the two steel ball sets is mounted between the annular shoulder of the respective mounting portion and the respective cover.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a crank shaft assembly in accordance with the preferred embodiment of the present invention;

FIG. 2 is a locally plan cross-sectional assembly view of the crank shaft assembly as shown in FIG. 1;

FIG. 3 is a plan cross-sectional assembly view of the crank shaft assembly as shown in FIG. 1;

FIG. 4 is a partially perspective cross-sectional assembly view of the crank shaft assembly as shown in FIG. 1; and

FIG. 5 is a plan cross-sectional assembly view of a conventional crank shaft assembly in accordance with the prior art.

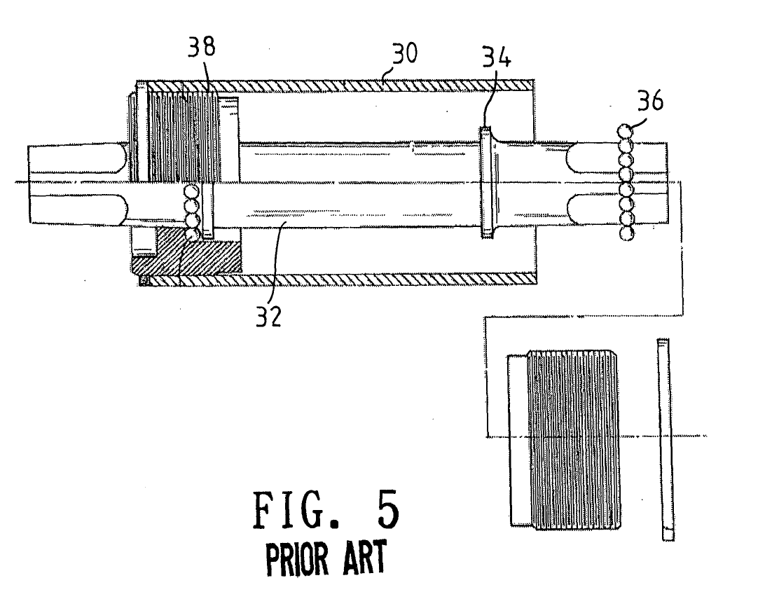

### DETAILED DESCRIPTION OF THE INVENTION

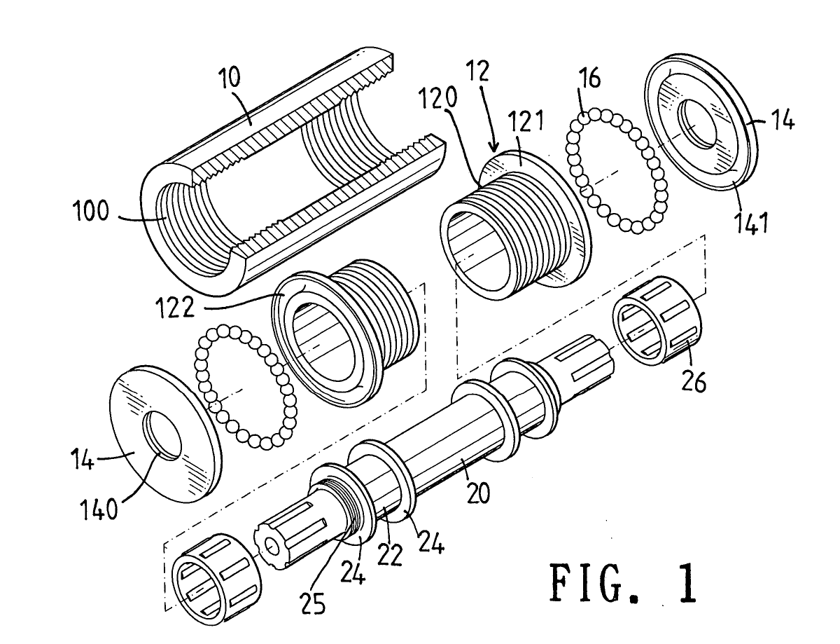

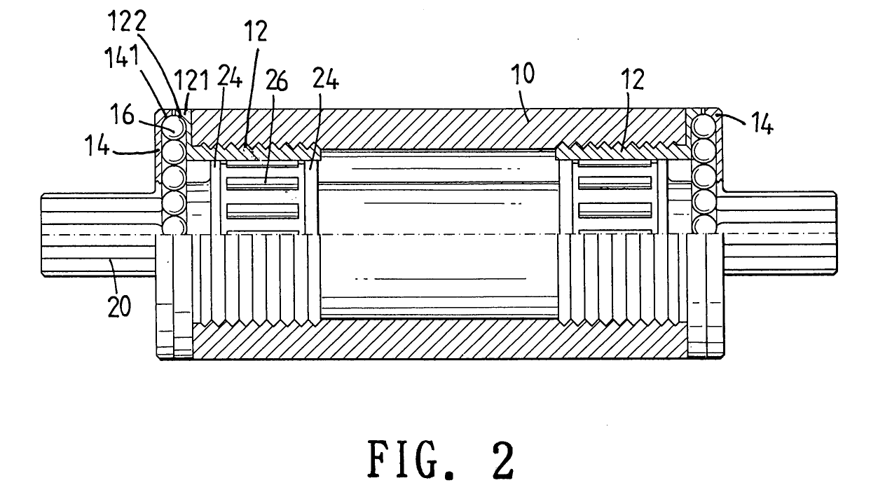

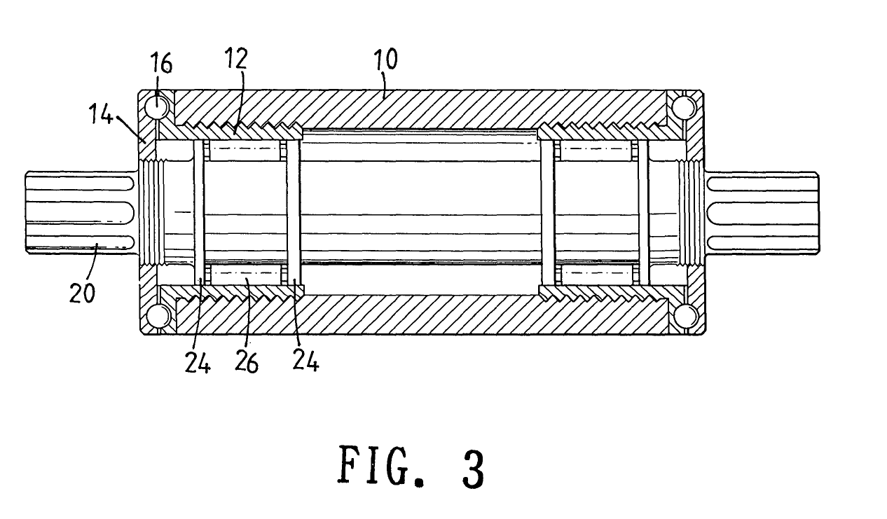

Referring to the drawings and initially to FIGS. 1-3, a crank shaft assembly for a bicycle in accordance with the preferred embodiment of the present invention comprises a socket 10, a crank shaft 20, two roller bearings 26, two mounting portions 12, two covers 14, and two steel ball sets 16.

The socket 10 has two ends each formed with an inner thread 100.

The crank shaft 20 is rotatably mounted in the socket 10. The crank shaft 20 has two ends each formed with a receiving recess 22. The receiving recess 22 of the crank shaft 20 is provided with two enlarged catch portions 24. Each of the two ends of the crank shaft 20 is provided with an outer thread 25 located at an outer side of one of the two catch portions 24.

Each of the two roller bearings 26 is mounted in the respective receiving recess 22 of the crank shaft 20 and located between the respective two catch portions 24.

Each of the two mounting portions 12 is mounted between the socket 10 and the crank shaft 20. Each of the two mounting portions 12 has an outer wall formed with an outer thread 120 screwed into the inner thread 100 of the respective end of the socket 10 and an inner wall rested on the respective two catch portions 24 of the crank shaft 20 to encompass the respective roller bearing 26. Each of the two mounting portions 12 has a distal end formed with an annular shoulder 121 rested on the respective end of the socket 10.

Each of the two covers 14 is secured on the respective end of the crank shaft 20 and is rested on the annular shoulder 121 of the respective mounting portion 12. Preferably, each of the two covers 14 is formed with an inner thread 140 screwed on the outer thread 25 of the respective end of the crank shaft 20.

Each of the two steel ball sets 16 is mounted between the annular shoulder 121 of the respective mounting portion 12 and the respective cover 14. Preferably, the annular shoulder 121 of each of the two mounting portions 12 is formed with an annular receiving groove 122 to receive the respective steel ball set 16. Preferably, each of the two covers 14 has a periphery formed with an annular receiving groove 141 to receive the respective steel ball set 16.

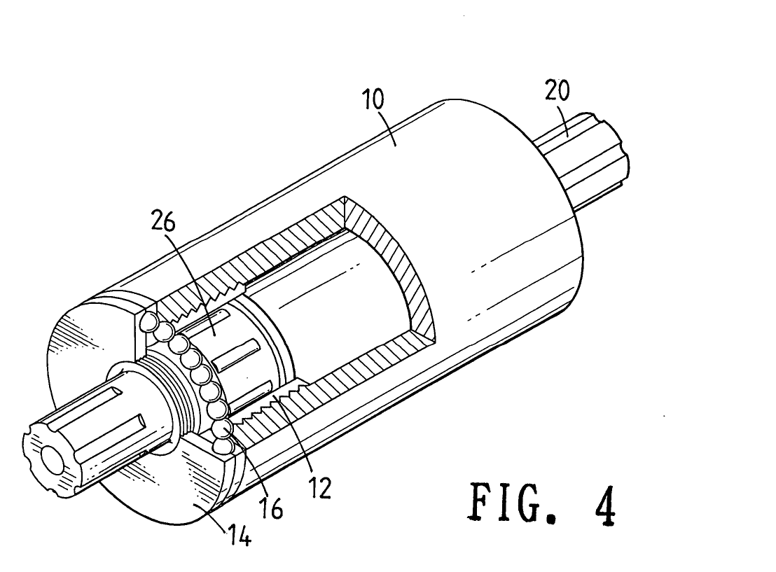

In practice, referring to FIGS. 1-4, the two roller bearings 26 and the two steel ball sets 16 are arranged in different axial directions so as to enhance the structural strength of the crank shaft assembly and to increase the force bearing area of the crank shaft assembly.

When the rider is riding the bicycle, the crank shaft assembly has to bear the force of the two cranks (not shown) and the weight of the rider. Thus, the crank shaft assembly needs a larger structural strength to bear the force of the two cranks and the weight of the rider. In such a manner, the two roller bearings 26 and the two steel ball sets 16 are arranged in different axial directions so as to bear the forces of different directions.

In assembly, the two roller bearings 26 are arranged at a mediate section of the crank shaft 20 and the two steel ball sets 16 are arranged at an outer side of the two mounting portions 12. In such a manner, the two roller bearings 26 and the two steel ball sets 16 are arranged in different axial directions so as to bear the forces and pressures of two different directions (vertical and horizontal directions). Thus, the crank shaft assembly has a larger structural strength to bear the forces and pressures of two different directions (vertical and horizontal directions). In addition, the two roller bearings 26 and the two steel ball sets 16 are arranged in different axial directions so as to increase the force bearing area of the crank shaft assembly, thereby preventing from producing stress concentration, so as to increase the lifetime of the crank shaft assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A crank shaft assembly, comprising a socket, a crank shaft, two roller bearings, two mounting portions, two covers, and two steel ball sets, wherein:
the crank shaft is rotatably mounted in the socket and has two ends each formed with a receiving recess;
each of the two roller bearings is mounted in the respective receiving recess of the crank shaft;
each of the two mounting portions is mounted between the socket and the crank shaft and has a distal end formed with an annular shoulder rested on the respective end of the socket;
each of the two covers is secured on the respective end of the crank shaft and is rested on the annular shoulder of the respective mounting portion; and
each of the two steel ball sets is mounted between the annular shoulder of the respective mounting portion and the respective cover.

2. The crank shaft assembly in accordance with claim 1, wherein the socket has two ends each formed with an inner thread, and each of the two mounting portions has an outer wall formed with an outer thread screwed into the inner thread of the respective end of the socket.

3. The crank shaft assembly in accordance with claim 1, wherein the receiving recess of the crank shaft is provided with two catch portions.

4. The crank shaft assembly in accordance with claim 3, wherein each of the two ends of the crank shaft is provided with an outer thread located at an outer side of one of the two catch portions, and each of the two covers is formed with an inner thread screwed on the outer thread of the respective end of the crank shaft.

5. The crank shaft assembly in accordance with claim 3, wherein each of the two mounting portions has an inner wall rested on the respective two catch portions of the crank shaft to encompass the respective roller bearing.

6. The crank shaft assembly in accordance with claim 3, wherein each of the two roller bearings is located between the respective two catch portions.

7. The crank shaft assembly in accordance with claim 1, wherein the annular shoulder of each of the two mounting portions is formed with an annular receiving groove to receive the respective steel ball set.

8. The crank shaft assembly in accordance with claim 1, wherein each of the two covers has a periphery formed with an annular receiving groove to receive the respective steel ball set.

9. The crank shaft assembly in accordance with claim 1, wherein the roller bearings and the steel ball sets are arranged in different axial directions.

10. The crank shaft assembly in accordance with claim 1, wherein the two roller bearings are arranged at a mediate section of the crank shaft.

11. The crank shaft assembly in accordance with claim 1, wherein the two steel ball sets are arranged at an outer side of the two mounting portions.
